(19) United States
(12) Patent Application Publication
(10) Pub. No.: US 2010/0236522 A1
(43) Pub. Date: Sep. 23, 2010

(54) Rotary Cylindrical Device With Coupled Pairs of Pistons

(76) Inventor: Jeffrey Page, Anaheim, CA (US)

Correspondence Address: AVERILL & GREEN, 8244 PAINTER AVE., WHITTIER, CA, 90602, US

(21) Appl. No.: 12/785,087

(22) Filed: May 21, 2010

Related U.S. Application Data
(63) Continuation-in-part of application No. 11/483,237, filed on Jul. 7, 2006, now Pat. No. 7,721,685.

(51) Int. Cl. F01B 3/04; F02B 75/26

(52) U.S. Cl. 123/43 AA; 123/56.1

(57) ABSTRACT

This invention is a cylindrical rotary power device, usable as and convertible to a rotary internal combustion engine, pump, and/or compressor. The device incorporates an ingenious design and composition utilizing bilateral symmetry to minimize power losses and maximize efficiency. It operates with a minimum of moving parts which can be manufactured at relatively low cost and readily maintained. Also, the power device of the present invention is readily converted to an internal combustion engine by merely removing the external power source and providing fuel flow and ignition charge to the cylinders.

The present application is a Continuation In Part of U.S. patent application Ser. No. 11/483,237 filed Jul. 7, 2006, which application is incorporated in its entirety herein by reference.

### BACKGROUND OF THE INVENTION

This invention relates to rotary power devices and more particularly to rotary internal combustion engines, pumps and compressors.

There have been many attempts to devise an efficient, axially aligned rotary power device. One such device was described in U.S. Pat. No. 6,601,548. The '548 patent discloses an array of parallel pistons arranged around a central shaft, with a system of roller cam followers to transmit power to the central shaft.

US Published Patent Application 2002/020,171 discloses a rotary power displacement fluid machine, with an eccentrically mounted central rotor and an array of axially-arranged vanes.

U.S. Pat. No. 5,209,190 describes an open-ended hosing with a central rotor assembly and parallel cylinder elements around the central shaft.

U.S. Pat. Nos. 6,782,866, 6,684,825, 6,672,275, and 6,484,687 describe a rotary machine and thermal cycle. This device does not use a compressive piston stroke, but instead uses and expansion ring and gear to generate pressure.

US Published Patent Application 2005/166,889 describes a rotary device with coupled chamber halves and a drive disk plate.

### BRIEF SUMMARY OF THE INVENTION

This invention is a cylindrical rotary power device, usable as and convertible to a rotary internal combustion engine, pump and compressor. The device incorporates an ingenious design and composition utilizing bilateral symmetry to minimize power losses and maximize efficiency.

It is an object of the present invention to provide a rotary power device both as an internal combustion engine and for compressing and pumping fluids.

Another object of the invention is to provide an improved rotary air compressor which maximizes output as compared to conventional pumps and compressors.

Another object of the invention is to provide in a single unit an engine and a compressor.

Another object of the invention a rotary power device which is readily convertible between an internal combustion engine and a pump or compressor.

Another object of the invention is to provide a rotary power device having relatively few parts.

Still another object of the invention is to provide a rotary power device having valveless ports which are substantially equal in diameter to the diameter of the pistons of the rotary device so as to reduce resistance to fluid inflow and outflow.

These and other objects and advantages of the present invention will be apparent from the following detailed description and from the recital of the appended claims, particularly when read in conjunction with the accompanying drawings.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 reveals a perspective view of a rotary power transfer device designed in accordance with the present invention and having a portion of the outer housing cut away for purposes of illustration;

FIG. 2 displays a frontal view of the outer face of the power transfer device of FIG. 1;

FIG. 3 shows a perspective view taken along line 3-4 of FIG. 1;

FIG. 4 shows a side sectional view taken along line 3-4 of FIG. 1;

FIG. 4A shows a side sectional view of a preferred embodiment of the present invention which comprises an internal combustion engine taken along line 3-4 of FIG. 1.

FIG. 4B shows a side sectional view of a preferred embodiment of the present invention which comprises an internally powered pump taken along line 3-4 of FIG. 1.

FIG. 5 comprises an exploded perspective view of the major components of the power transfer device of FIG. 1;

FIG. 6 comprises an exploded perspective view of a piston and bearing connector of the power transfer device designed in accordance with the present invention;

FIG. 7 demonstrates a side view of the assembled piston from the parts shown in FIG. 6.

FIG. 8 indicates a view from the perspective of the crankshaft of the assembled piston of FIG. 7, and rotated 90 degrees therefrom.

FIG. 9 displays an exploded perspective view of the crankshaft and power train of the power transfer device designed in accordance with the present invention;

FIG. 10 demonstrates a side view of the assembled power train of FIG. 9; and,

FIG. 11 displays a side view of the assembled power train of FIG. 10, and rotated 90 degrees therefrom.

FIG. 12 shows an embodiment of the present invention having parallel coupled pistons according to the present invention.

FIG. 13 shows a perspective view of one of the parallel coupled pistons according to the present invention.

FIG. 14 shows a side view of a single parallel coupled pistons according to the present invention in relationship to a crankshaft and one end of the stationary block containing cylinders.

FIG. 15 shows a top view of the single parallel coupled pistons according to the present invention in relationship to the crankshaft and one end of the stationary block containing cylinders.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

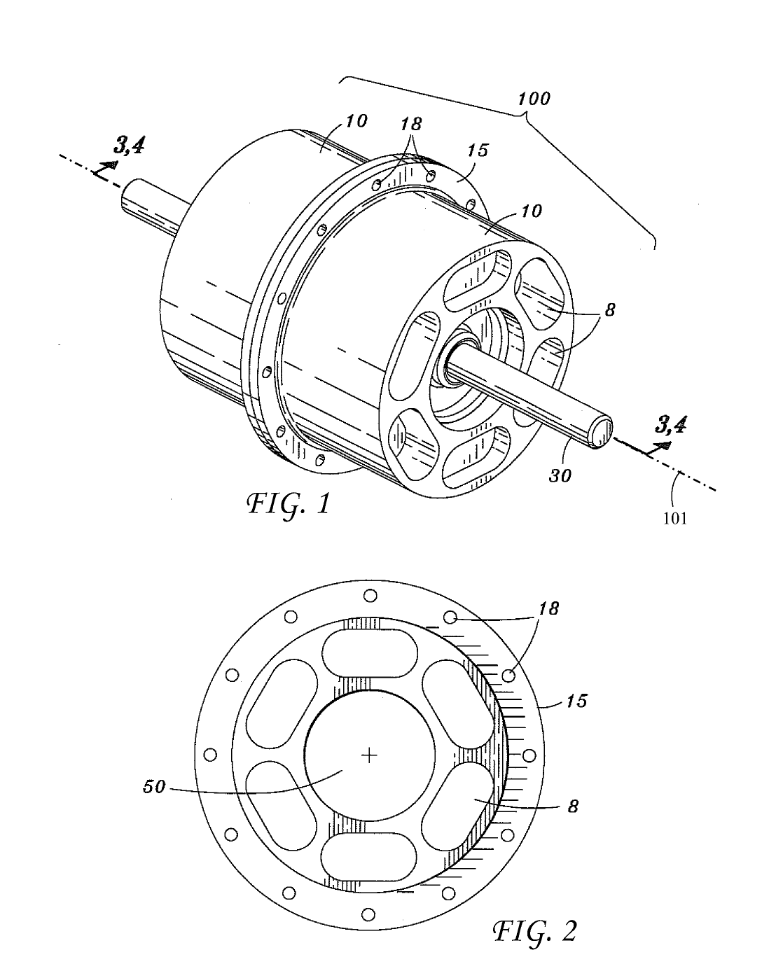

In the accompanying FIGS. 1-11, for the purposes of illustrating the principals of this invention, there is disclosed a rotary power generation and transfer device. It will be understood, that various features of this invention, particularly the input and output of the reciprocating pistons and the translation of reciprocating motion to rotary motion and vice versa, have utility and may be successfully employed with a variety of operational devices, as for example, with pumps, steam engines, internal combustion engines, and the like.

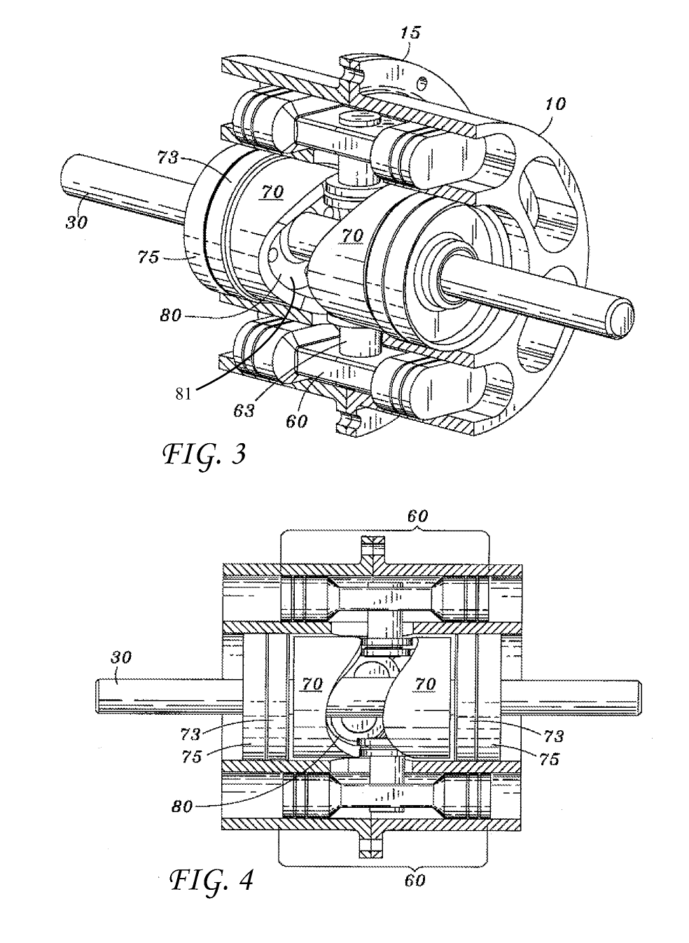

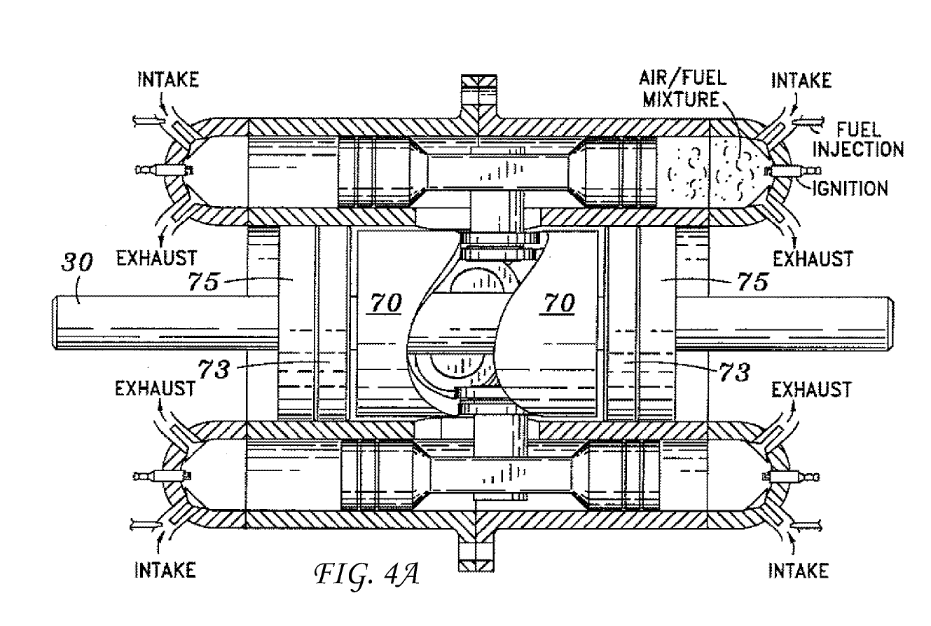

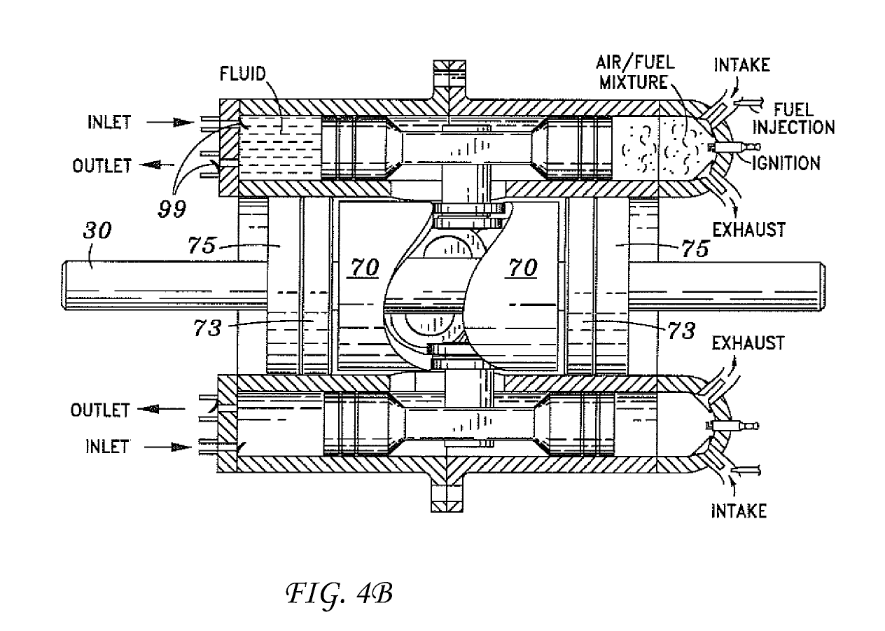

Referring to FIGS. 1-11, the rotary power device of the present invention, shown generally as 100, includes an outer piston and cylinder block assembly, an inner power train sleeve, and a crankshaft. The crankshaft can be rotatably powered by the pistons, acting in an internal combustion engine mode as shown in FIGS. 4A and 4B. Alternatively, the crankshaft can be externally powered from an external power source (not shown), thereby powering the cylinders in a reverse mode as shown in FIG. 3. Powered in this fashion, the current invention can operate as a pump.

A perspective view of the outer surface of the preferred embodiment of the current invention is displayed in FIG. 1. Seen in this figure is the basic piston and cylinder block of the current invention, arranged in a preferred cylindrical array. The block itself is comprised of two similar or identical half-blocks 10, which mate together at their bases via a component central ring 15. A series of apertures 18 appear around the ring. These are disposed for placement of bolts or other connectors to join the halves 10 together to form a completed block. Inside the block is the crankshaft 30, axially disposed along the centerline of the block.

FIG. 2 displays the block 10 from an end-on view. The block 10 contains a variety of apertures comprising cylinders 8, fastener apertures 18, and large central aperture 50. The cylinders 8, of course, are the housings for the pistons, as shown in later figures. The central aperture 50 is the home of the power train, also shown later. A total of 6 cylinders, and thus 6 pistons are displayed, although other numbers, for instance 4 or eight cylinder and piston pairs are contemplated.

It will be noted that these cylinders 8 have an oval cross section. This is not required, and other geometric shapes, for instance a circular cross section, are contemplated. However, tests have indicated that the oval shape provides better power per cylinder bore size, and thus is preferred in the current embodiment of the present invention.

FIG. 3 reveals an open sectional view of the current invention, with both cylinder block and power train components on display. Two of the pistons 60 are shown, in operational position. These are connected to the power train by bearing pins 63. The power train comprises crankshaft 30, bearing seals 75, bearings 73, and power sleeves 70. The two power sleeves 70 do not connect, but instead are separated by a curved power track 80 having constant width. As the pistons move up and down within their cylinders, they are connected to the power train via the bearing pins 63 which mate to the curved power track 80. Thus, crankshaft 30, if externally powered as shown in FIG. 3, can transmit power via the curved power track 80 and pins 63 in reverse direction, forcing pistons 60 to move up and down. This is useful, for example, to create a pump. Alternatively, if the pistons are operating in internal combustion mode as shown in FIG. 4A, they will transmit power via pins 63 to the curved power track 80, forcing the curved power track 80, the power sleeves 70, and the entire power train including crankshaft 30 to rotate around the long axis, or if operating on one side as in FIG. 4B, the opposing side may be used as a pump. Power sleeves 70 have a hollow hollow cylinder body portion 81 shown in FIGS. 3, 5, and 9.

FIGS. 4A and 4B show the same section view of FIG. 3, from a side plan view when the pistons are operating in an internal combustion mode. In contrast to FIG. 4a, in which all of the pistons are operating in the internal combustion mode, FIG. 4B shows an embodiment of the present invention in which the right side of the engine is operating in the internal combustion mode and the left side of the engine is operating as a pump or compressor, with check-valves 99 preventing a back flow. Both upper and lower pistons 60 are shown, each in a position approximately halfway up the cylinder. The bearing pins 63 are shown, connecting each piston 60 to the curved power track 80 formed by the adjacent power sleeves 70. The power sleeves are greeted on their outer faces by bearings 73, which aid in holding the power sleeves in place, and thus preserving curved power track 80. Outside of bearings 73 are bearing seals 75, which seal off the power sleeves and bearings from the outside, thus excluding contaminants and preserving lubricant. The entire assembly is typically lubricated by a charge of lubricating oil, which circulates via ports between the cylinder walls, pistons, bearings, power sleeves, and crankshaft.

FIG. 5 introduces an exploded view of the preferred embodiment 100 of the current invention. At either end are the two unit halves 10 of the cylinder block. Shown on the right side block is the outer face of one block unit half 10, as it appears in earlier figures. Displayed on the left side unit block half is the inner face 17, which faces the interior of the current invention.

The pistons 60 that normally reside within cylinders 8 are shown in exploded view in this figure. The pistons are in approximately the arrangement they will hold when in position within the cylinders. Each piston has a bearing pin 63 which is disposed at right angles to the piston, and intersects the piston at the midsection, in between the piston heads 61. Each bearing pin 63 has a top bearing ring 65, to secure the pin on one side of the piston, and a pair of bearing pins 67 on the opposite side of the piston.

Also shown in FIG. 5 is the power train 200 of the current invention. In simplified, assembled form, the power train comprises a pair of power bearing assemblies 300 separated by a curved power track 80, and surrounding a crankshaft 30.

It can be seen from this exploded view, in combination with the views of earlier figures, especially FIGS. 4A and 4B, how the pistons 60 connect with the power train 200 to transmit power to the crankshaft. The pistons are connected by bearing pins 63, which culminate in a pair of bearing rings 67. This pair of rings can fit inside curved power track 80, or be disposed with one ring inside and one just outside the track. This secures the connection to the power train, as the curve is comprised by power sleeves 70, which are themselves connected to (or integrally part of) crankshaft 30.

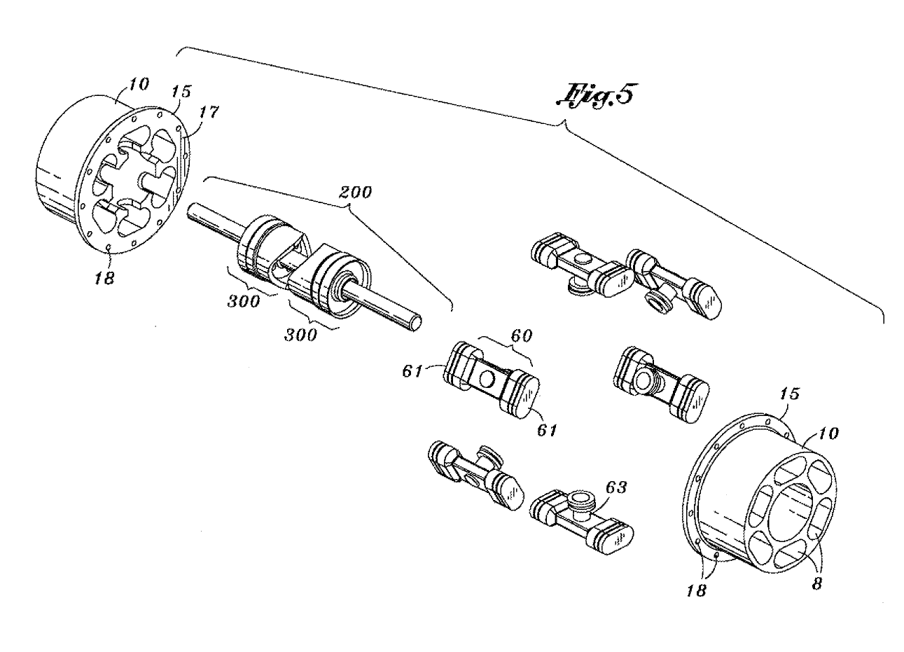

Now moving to FIG. 6, a piston and bearing pin assembly is displayed in exploded view. The piston 60 is comprised of two large piston heads 61, and a thin central body 62, with an aperture 64 at its midpoint. The piston heads 61 are oval in cross section, and are designed to fit closely within a cylinder 8. Piston heads 61 are circumscribed by grooves 66 for lubricating oil.

Bearing pin 63 is designed to closely fit within piston midpoint aperture 64. Each piston has one associated bearing pin 63, one upper bearing ring 65, and two lower bearing rings 67. The upper bearing ring 65 prevents pin 63 from escaping the piston 60 at one end. The lower pair of bearing rings 67 connect the bearing pin 63 to curved power track 80, and secure the bearing pin 63 thereto.

FIG. 7 illustrates the completed piston and bearing pin assembly 600 from a side view. The piston 60 is shown to be symmetrical in shape, with dual piston heads 61. Piston 60 is intersected at a right angle by bearing pin 63. Pin 63 has bearing ring 65 secured at its top end, and a pair of bearing rings 67 secured at its bottom end. It should be noted that bearing rings 67 could be identical with bearing ring 65, except for their association as a pair, and their function to connect pin 63 to the curved power track 80.

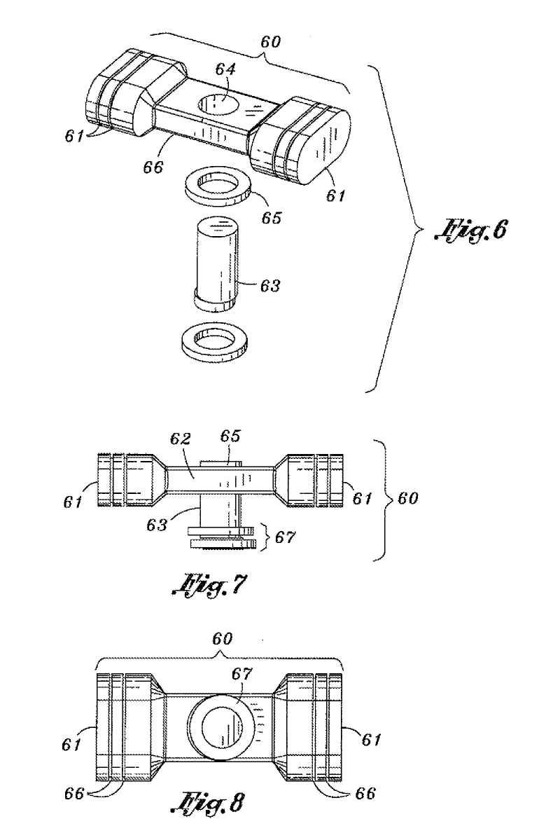

FIG. 8 shows the same completed piston and bearing pin assembly 600 from a view 90 rotated from FIG. 7. This view is from the direction of the power train 200.

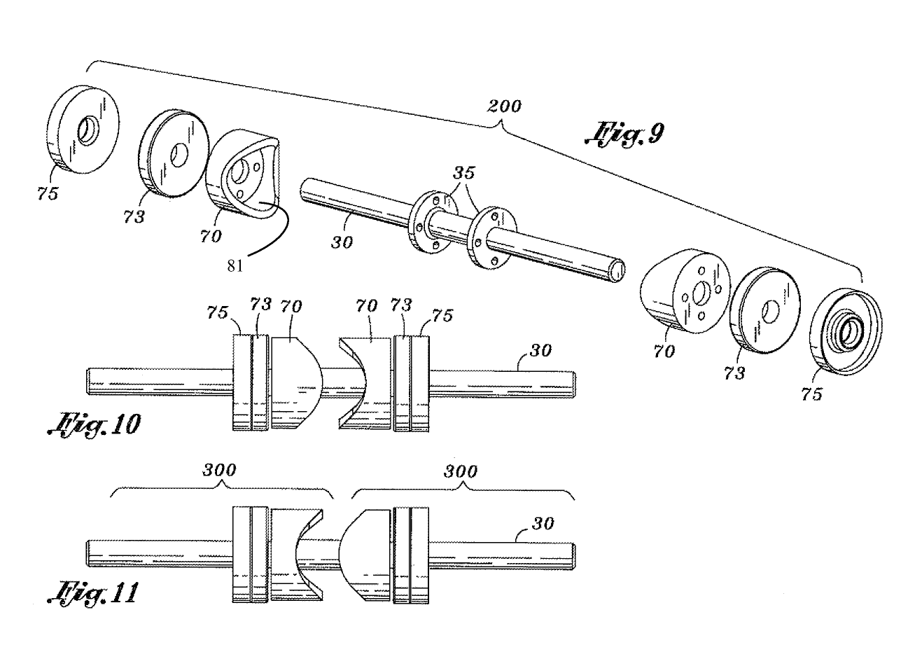

FIG. 9 displays the power train assembly 200 in exploded view. The bilateral symmetry of the power train is evident, as indeed is reflected in the same symmetry of the invention 100 as a whole. The elements of power train 200 are shown, starting with crankshaft 30, which contains a pair of mounting brackets 35 on either end of the midpoint. These mounting brackets 35 are each fastened to the inner face of a power sleeve 70. This disposes the power sleeves in the correct relationship to establish curved power track 80.

Power sleeves 70 are connected at their respective outer faces to bearings 73. These help distribute the weight and load of the power train. At the other, outer sides of bearings 73 are placed seals 75. As noted above, the seals prevent outer contamination and seal the power train off from the outside, excepting crankshaft 30, which communicates to a drive train for powering a vehicle or motor, perhaps, or for accepting power from an external source.

When the current invention operates as an internal combustion engine, it will include fuel injection means at intake ports of each cylinder for the delivery of a fuel to open ends of said cylinder elements as they rotate. Also, there will be means for initiating ignition of said air fuel mixture after it is compressed within said cylinder element, such as a spark ply appurtenant to each cylinder. Additionally, there will be an exhaust manifold communicating with each of a set of outlet ports on each cylinder, for receiving combustion products from said cylinder elements during the exhaust stroke of said pistons.

FIG. 10 illustrates the completed power train assembly 200 from a side view. Curved power track 80 is clearly shown at the center of the figure, bowed to the right in this view. The elements of the crankshaft 30, power sleeves 70, bearings 73, and seals 75 are displayed.

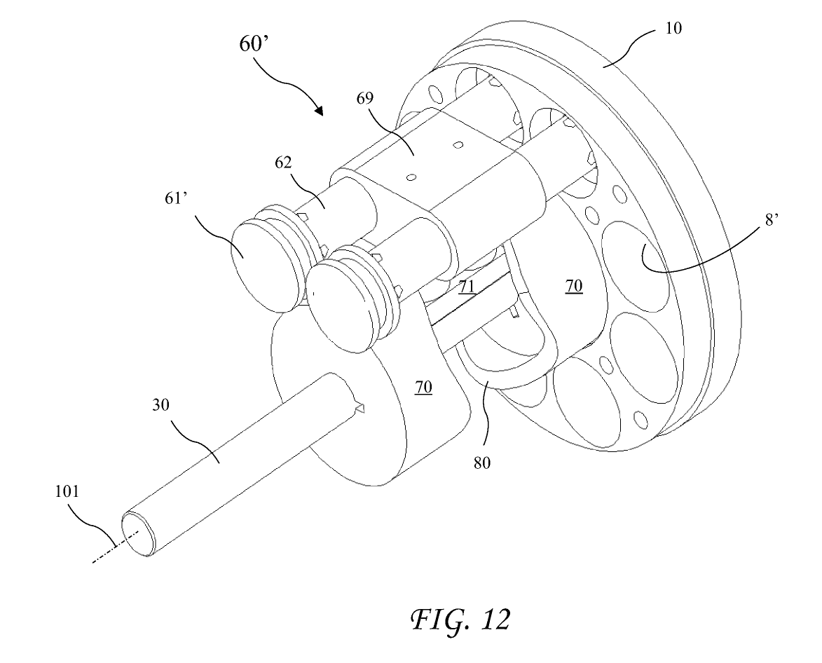

FIG. 11 shows the same completed power train assembly 200 from a view 90 degrees rotated from FIG. 10. This view shows the curved power track 80 bowed to the left, and illustrates the up-and-down sinusoidal-like motion of curved power track 80. This is necessary, as the track must meet up with itself on completing the circumference of the power train.

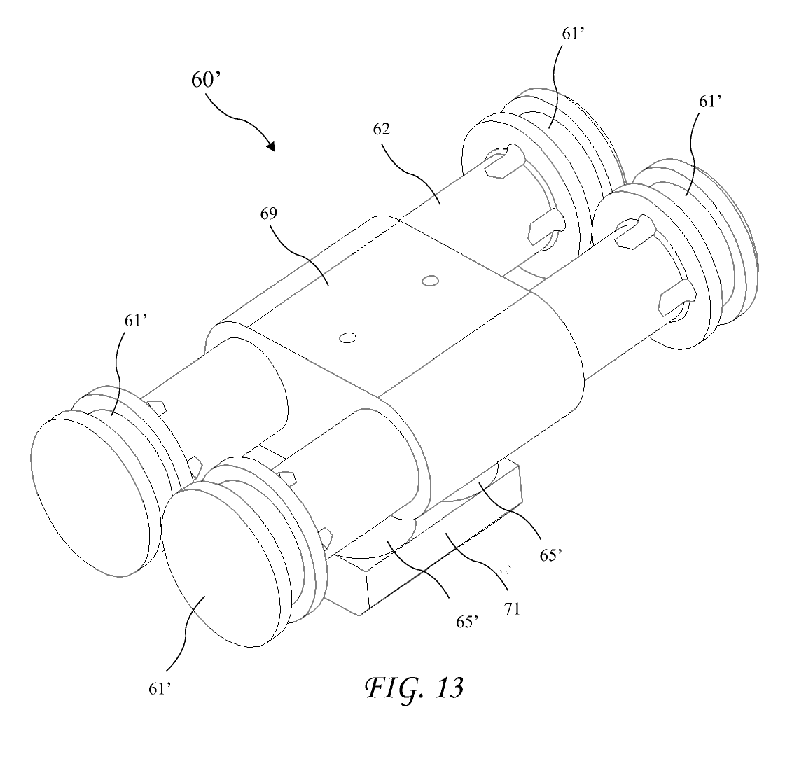

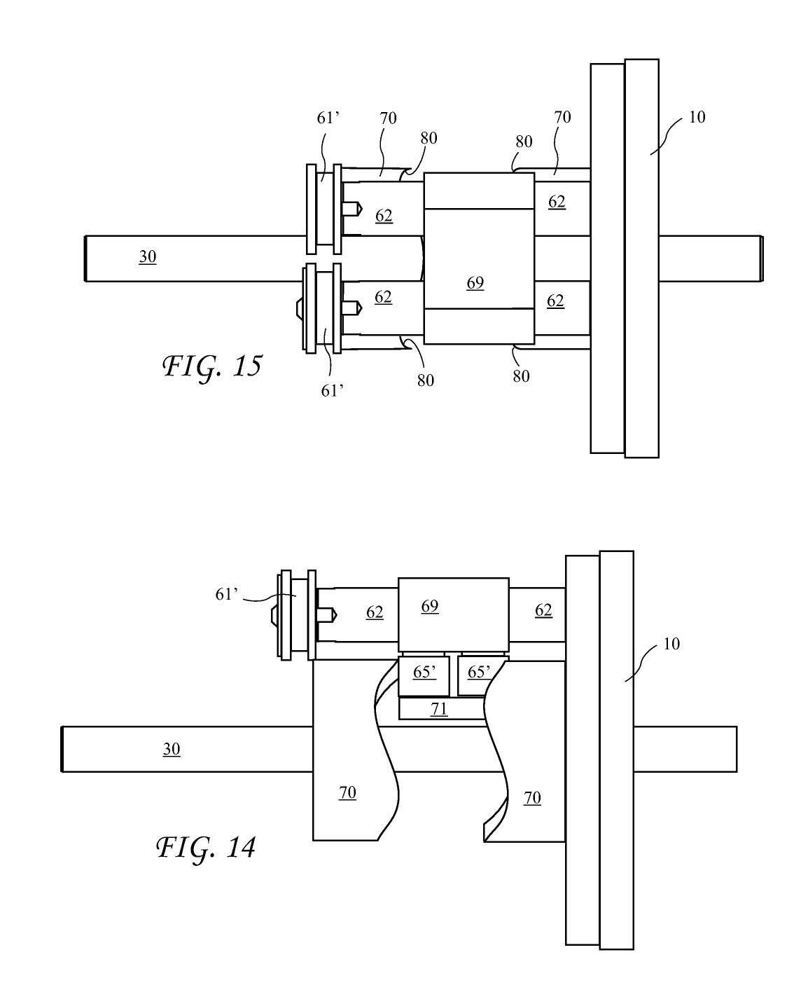

A paired piston embodiment of the present invention is shown in FIGS. 12-15. FIG. 12 shows an embodiment of the present invention having parallel coupled pistons according to the present invention. FIG. 13 shows a perspective view of one of the parallel coupled pistons according to the present invention. FIG. 14 shows a side view of a single parallel coupled pistons according to the present invention in relationship to a crankshaft and one end of the stationary block containing cylinders. FIG. 15 shows a top view of the single parallel coupled pistons according to the present invention in relationship to the crankshaft and one end of the stationary block containing cylinders.

The embodiment of FIGS. 12-15 includes piston assemblies 60′ comprising parallel pairs (or larger groups) of coupled round pistons heads 61′ replacing the oval piston heads 60 described above. The oval piston heads 60 limited or prevented the rotation of the pistons 60, which rotation results in miss-alignment of the bearing rings (or can followers) 65 with the power sleeves 70. However, sealing oval pistons is more difficult than sealing round pistons. The parallel coupled (side by side) piston heads 61′ limit or prevent rotation of the piston assemblies 60′ as means of steering the cam followers (rollers) 65′ (see FIG. 14) without adding any additional mechanism. The cam followers 65′ reside on cam follower pins (or spindles) 63 reaching radially inward from yokes 69 of each of the parallel paired piston assemblies 60′. The cam follower pins 63 are supported at inner ends by bridges 71 providing a load path across both cam follower pins 63, allowing for smaller cam follower pins and a more compact mechanism.

The paired pistons further provide a path for carrying a flow being pumped from cylinder to cylinder (cylinders on opposite ends of the machine) without having to be plumbed out side of the cylinders or outside of the machine. The flow may also be carried to cylinders side by side by a path through the yoke to an adjacent coupled piston.

The cylinders and pistons associated with a particular yoke may be of different diameters to function as a compound compressor and the yokes may be constructed to couple any number of pistons in any parallel arrangement. The inertial forces associated with the reciprocating motions of the pistons may be utilized to enhance the operations of any of various valve mechanisms contained within the pistons.

The embodiment of FIGS. 12-15 may be incorporated into an engine, a pump, a combination engine and pump, and generally into any apparatus disclosed in FIGS. 1-11, and any reciprocating device having grouped parallel pistons and pairs of cam followers riding in separate curved tracks is intended to come within the scope of the present invention.

It should be noted, however, that curved power track 80, though necessarily having a repeating path, can define a steeper or less steep curve. The steeper the curve, the longer the piston 60 travel path within cylinder 8, and thus the higher compression can be reached. However, the curved power track 80 is limited by the physical dimensions of piston 60 and cylinder 8. Thus, larger and longer cylinders and pistons will be accommodated by steeper curved power tracks 80. The steepness of the curve is defined by the shape of the inner face 77 of power sleeves 70.

It will be understood that in the example set forth above, that the stroke and compression ratio can be increased by lengthening the curved power track 80 of the power train so that the output of air is at a higher pressure than 160 pounds. The dimensions of the bore of the cylinder 8 and the dimensions of the pistons 60 can be increased to increase the output of compressed air. Likewise, the size of the device can be increased and the number of cylinder elements and pistons may be increased, for example from 4 to 8 cylinder elements. However, the pump can operate effectively with as few as two cylinder elements.

The apparatus described herein produces a highly efficient compressor and/or pump for compressing or moving fluids. It operates with a minimum of moving parts which can be manufactured at relatively low cost and readily maintained. Also, the power device of the present invention is readily converted to an internal combustion engine by merely removing the external power source and providing fuel flow and ignition charge to the cylinders.

As will be understood by those skilled in the art, various arrangements other than those described in detail in the specification will occur to those persons skilled in the art, which arrangements lie within the spirit and scope of the invention. It is, therefore, to be understood that the invention is to be limited only by the claims appended hereto.

While the invention herein disclosed has been described by means of specific embodiments and applications thereof, numerous modifications and variations could be made thereto by those skilled in the art without departing from the scope of the invention set forth in the claims.

I claim:

1. A rotary power device comprisisng:
a stationary block having a central axis;
a plurality of axially oriented angularly spaced apart cylinders formed within said block;
an axially disposed, rotatable crankshaft supported by the stationary block;
a power sleeve attached to the rotatable crankshaft and rotating with the rotatable crankshaft;
opposed curved tracks residing on the power sleeve;
a plurality of dual headed pistons including coupled pairs of parallel opposed piston heads slidingly supported in each of the axially oriented angularly spaced apart cylinders;
cam follower pins supported by each of the dual headed pistons, the cam follower pins extending radially inwardly;
pairs of offset cam followers rotatably carried by the cam follower pin, each of the cam followers riding on only one of the opposed curved tracks so that as the curved tracks rotates with respect to said block, the piston heads reciprocate in the cylinders as said cam followers ride on said curved tracks.

2. The power train assembly of claim 1, wherein the piston heads comprise round piston heads.

3. The power train assembly of claim 1, wherein the cam follower pins comprise pairs of axially spaced apart cam follower pins, one can follower rotatably residing on each cam follower pin.

4. The power train assembly of claim 1, wherein inner ends of the pairs of cam follower pins are joined by a cam follower pin support block.

5. A rotary power device (100) having a stationary block (10) having a central axis (101), said block (10) supporting an axially disposed, rotatable crankshaft (30), a plurality of axially oriented angularly spaced apart cylinders (8) formed within said block (10), said rotatable crankshaft (30) supporting a curved track (80), a plurality of dual headed pistons (60) slidingly supported in each of said axially oriented spaced cylinders (8), each piston (60) supporting a cam follower pin (63) which extends radially inwardly and terminating in a cam follower member (67) riding in said curved track (80) so that as the curved track (80) rotates with respect to said block (10), the pistons (60) oscillate in the cylinders (8) as said cam follower members (67) ride in said curved track (80) wherein the improvement of said power train assembly comprising:
coupled pairs of parallel opposed piston heads 61′ slidingly supported in each of the axially oriented angularly spaced apart cylinders (8),
wherein:
the curved track (80) being formed by two adjacent separate opposing power sleeves (70);
one/each of said two power sleeves has a hollow cylindrical body portion (81) spaced from said rotatable crankshaft (30) and is secured to said rotatable crankshaft on an inner surface of a power sleeve (70) on an outer surface of one of a pair of mounting brackets (35) which are axially and rotationally fixed to said rotatable crankshaft; and
wherein said one/each of the power sleeves (70) forms one half of said curved track (80).
